(19) United States
(12) Patent Application Publication
(10) Pub. No.: US 2026/0056798 A1
(43) Pub. Date: Feb. 26, 2026

(54) Scalable Find First N Techniques

(71) Applicant: Apple Inc., Cupertino, CA (US)

(72) Inventors: Liang Xia, Austin, TX (US); Casper R. van Benthem, Hertfordshire (GB); Andrea Uguagliati, Bee Cave, TX (US)

(21) Appl. No.: 18/815,501

(22) Filed: Aug. 26, 2024

(51) Int. Cl. G06F 9/50

(52) U.S. Cl. CPC G06F 9/5044

(57) ABSTRACT

Techniques are disclosed relating to resource arbitration and allocation methods for multiple requesters, e.g., in graphics processors. In some embodiments, an apparatus includes find-first N circuitry configured to find the first N valid signals in a prioritized vector of input signals, and multiple node circuits configured in a hierarchical tree. A given node circuit includes control circuitry configured to receive first and second sets of more-than (MT) signals from parent nodes and generate output MT signals indicating the number of valid signals received by ancestor nodes. The node circuit also includes path control circuitry configured to receive first and second sets of path vectors from parent nodes and generate output path vectors representing the locations of valid signals in the input vector. The apparatus may also include round-robin control circuitry to provide fair arbitration among multiple requesters, and mapping circuitry to assign valid requesters to identified resources.

### BACKGROUND

### Technical Field

This disclosure relates generally to computer processors and more particularly to hardware resource arbitration and allocation among multiple requesters, multiple resources, or both.

### Description of Related Art

In modern computing systems, Graphics Processing Units (GPUs) and System-on-Chip devices (SoCs) are integral in handling complex computations, particularly in graphics rendering and parallel processing tasks. In this context, arbitration and allocation are important, e.g., to distribute of limited hardware resources among multiple requesters. In many scenarios, an arbiter may select N resources allocate to requesters, select N requesters to receive grants of requested resources, or both. This selection process is often on the critical path of the system's operation, making it crucial to perform these selections quickly and efficiently. Traditional approaches to resource arbitration may struggle to balance performance and complexity, especially as the number of resources and requesters increases.

### BRIEF DESCRIPTION OF DRAWINGS

FIG. 1A is a diagram illustrating an overview of example graphics processing operations, according to some embodiments.

FIG. 2 is a block diagram illustrating a hierarchical tree of nodes, according to some embodiments.

FIG. 3 is a block diagram illustrating example more-than propagation logic of a given node, according to some embodiments.

FIG. 4 is a block diagram illustrating example path propagation logic of a given node, according to some embodiments.

FIG. 5 is a block diagram illustrating a detailed example with path vectors and MT signals at a node, according to some embodiments.

FIG. 6A is a block diagram illustrating an example of a find-first N system for resources, according to some embodiments.

FIG. 6B is a block diagram illustrating an example of a find-first N system for requesters, according to some embodiments.

FIG. 7 is a flow diagram illustrating an example method, according to some embodiments.

FIG. 8 is a block diagram illustrating an example computing device, according to some embodiments.

FIG. 9 is a diagram illustrating example applications of disclosed systems and devices, according to some embodiments.

FIG. 10 is a block diagram illustrating an example computer-readable medium that stores circuit design information, according to some embodiments.

### DETAILED DESCRIPTION

As discussed above, resource arbitration and allocation may be important for maintaining performance and efficiency, e.g., in Graphics Processing Units (GPUs) and System on Chip devices (SoCs). For example, arbitration may be used to assign requesters to hardware resources in various scenarios, e.g., to: assign threads to execution circuitry, select cache lines for eviction, select which instructions are allowed to read their source operands, etc. This list is included to provide examples to facilitate explanation, but it is well understood that processors utilize resource arbitration in a large variety of different applications, where speed, power consumption, circuit area, input vector width, maximum number of winners per arbitration, etc. may be important design considerations.

In some examples, traditional methods of finding the first N resources/requesters for arbitration may be deficient in terms of speed, chip area, or both, particularly when scaling N. In some embodiments, efficient allocation of resources among multiple requesters, such as threads or processes, may be particularly challenging in systems with a large number of requesters and limited resources. Existing techniques may fail to balance performance and complexity adequately, leading to potential bottlenecks and suboptimal resource utilization.

In some embodiments, a hierarchical tree of node circuits is configured to find the first N valid signals in a prioritized vector of input signals, which may provide scalable performance with reasonable area. Generally, the tree may propagate more-than (MT) signals that indicate whether portions of the vector of input signals, processed by a cone of ancestor nodes, include more than a given number of valid inputs. The tree may use these MT signals to select and augment path vectors from parent nodes, where a given path vector represents the location of a valid signal in the prioritized vector of input signals. Specifically, in some examples the incoming MT signals control multiplexers (MUXes) to select from the incoming paths and control circuitry adds a bit to selected paths depending on whether they came from the left or right-hand parent node.

In some embodiments, the path vectors and tree size grow with increasing N. The number of nodes may halve at each level of the tree however, providing low circuit area and high performance for arbitration circuitry (e.g., O(log(N)), in some embodiments).

### Graphics Processing Overview

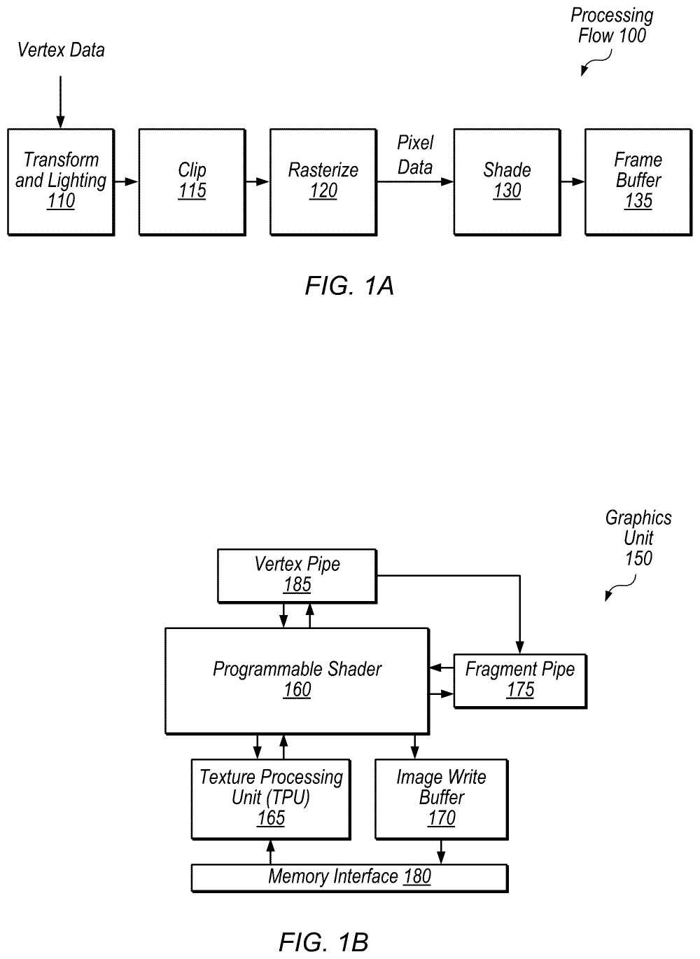

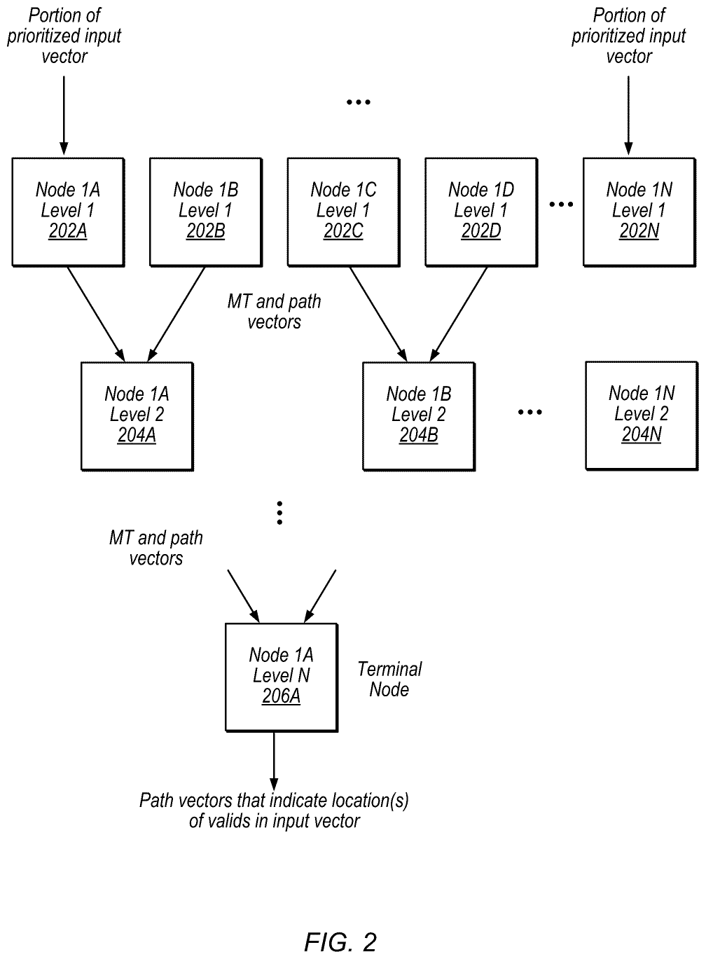

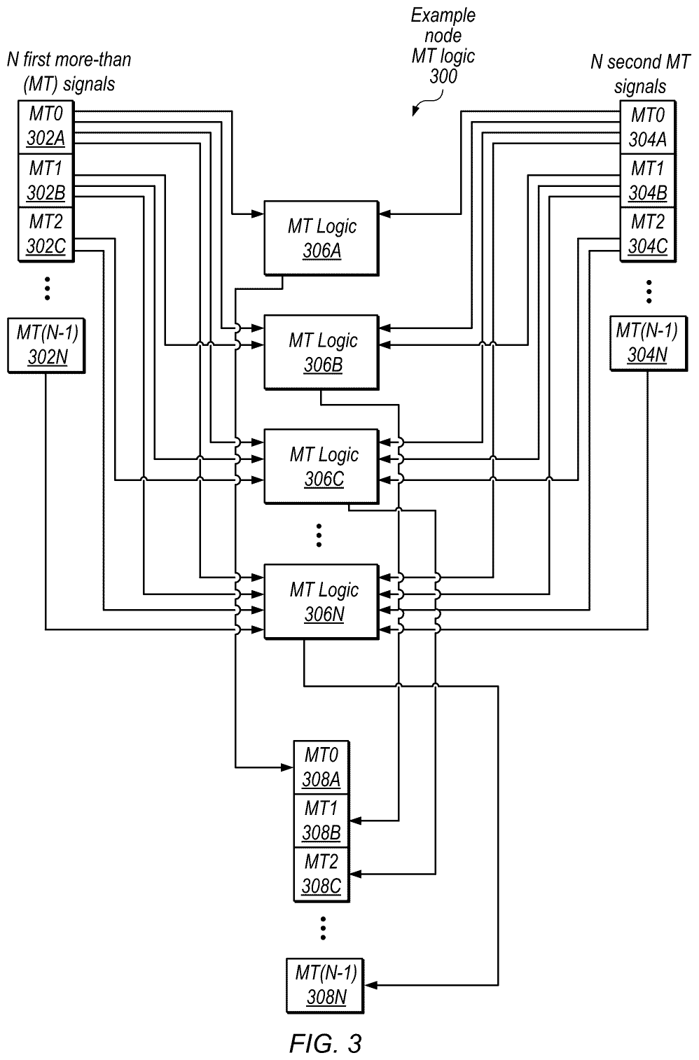

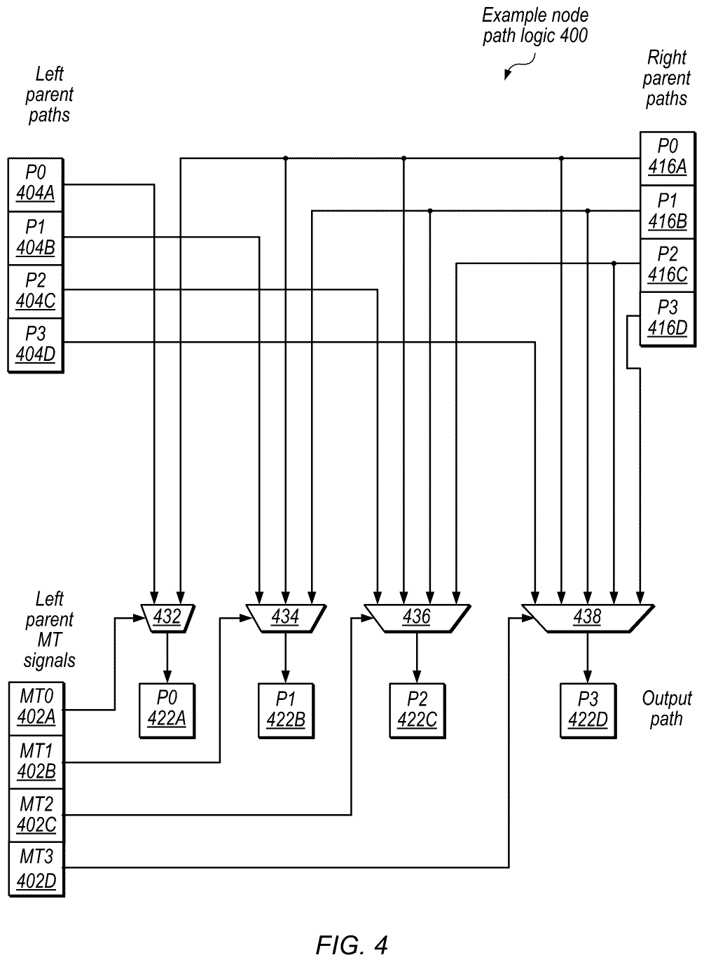

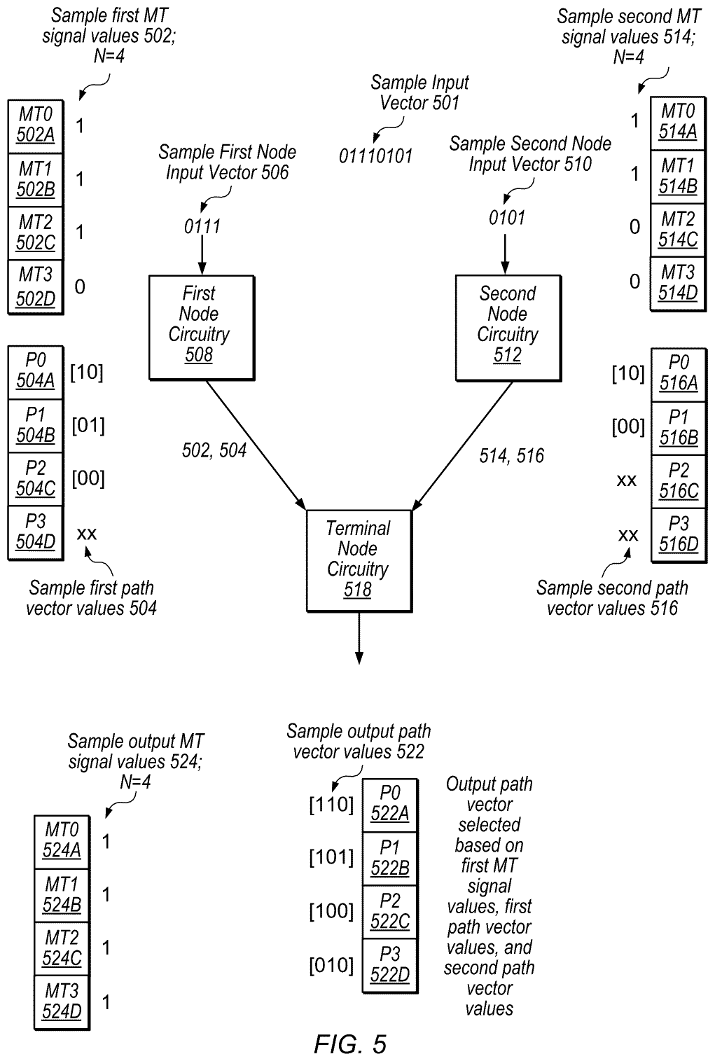

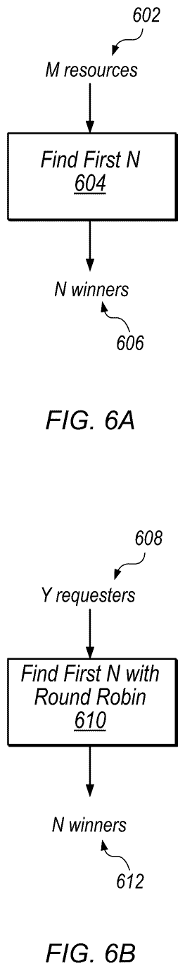

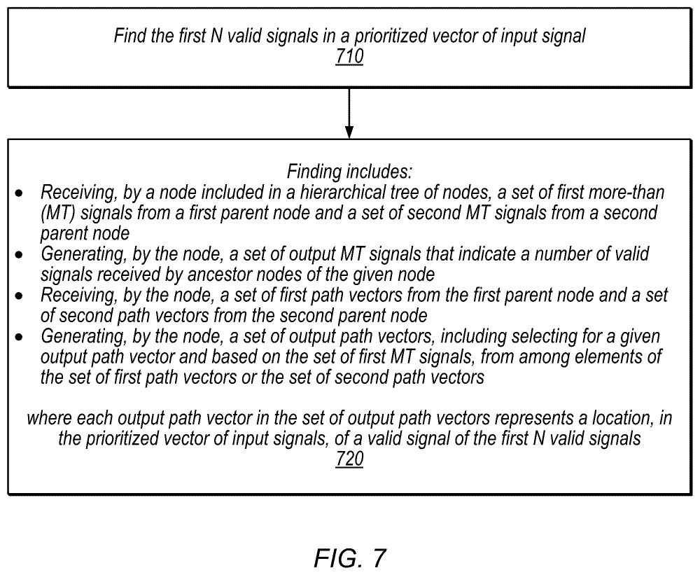

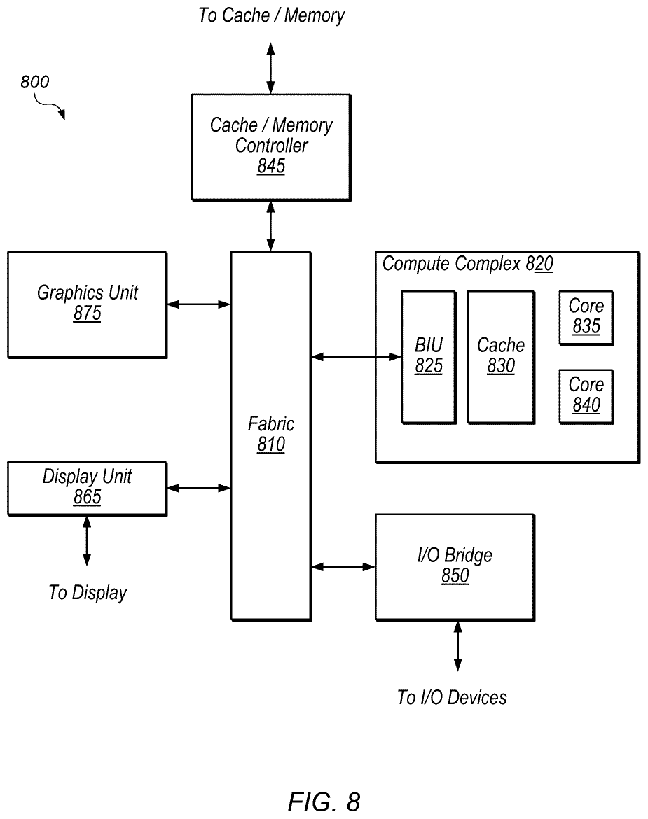

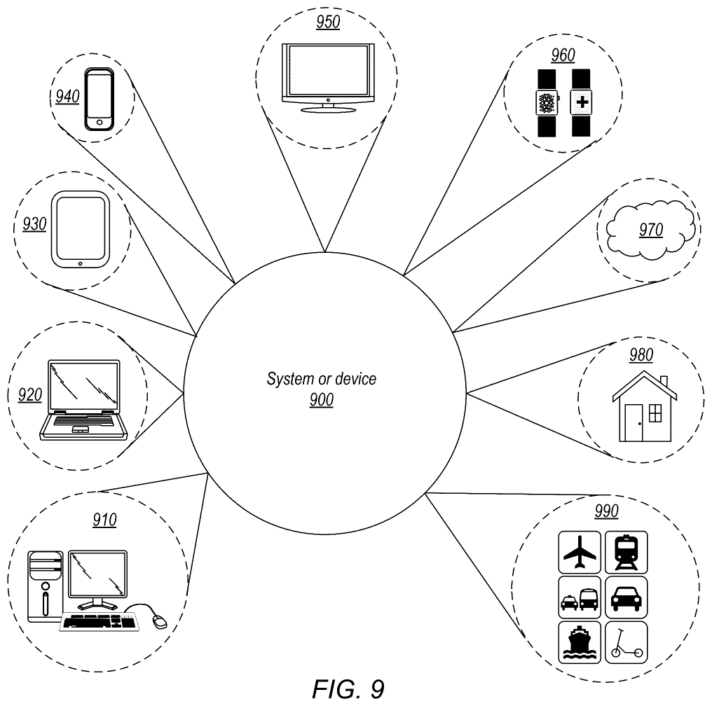

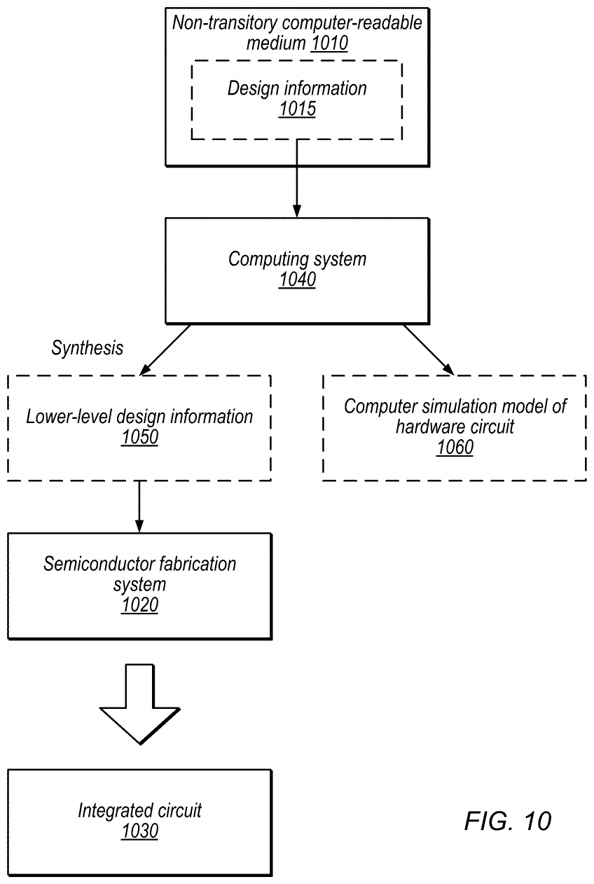

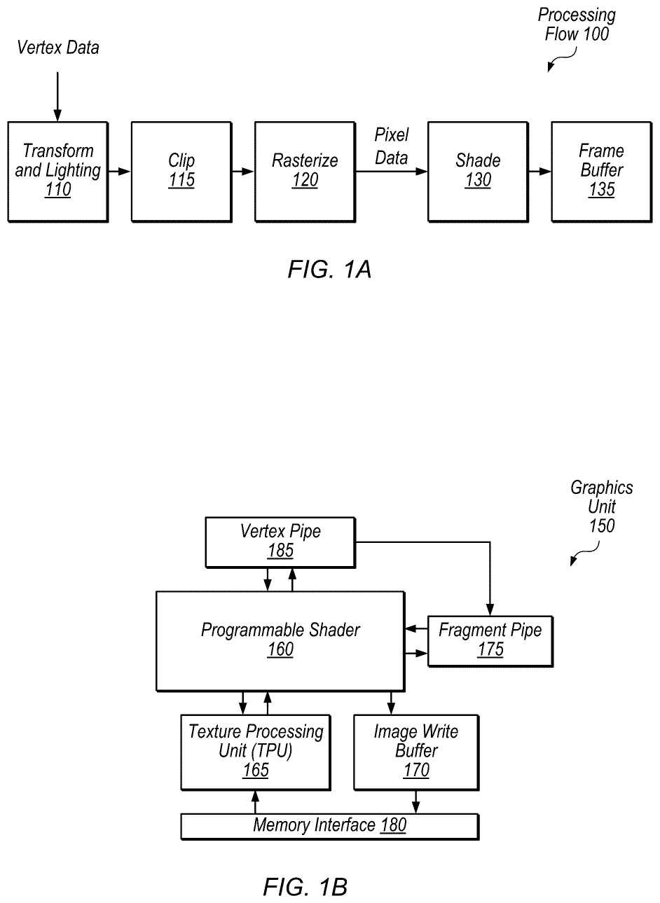

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

### Overview of Tree-Based Find-First-N Circuitry

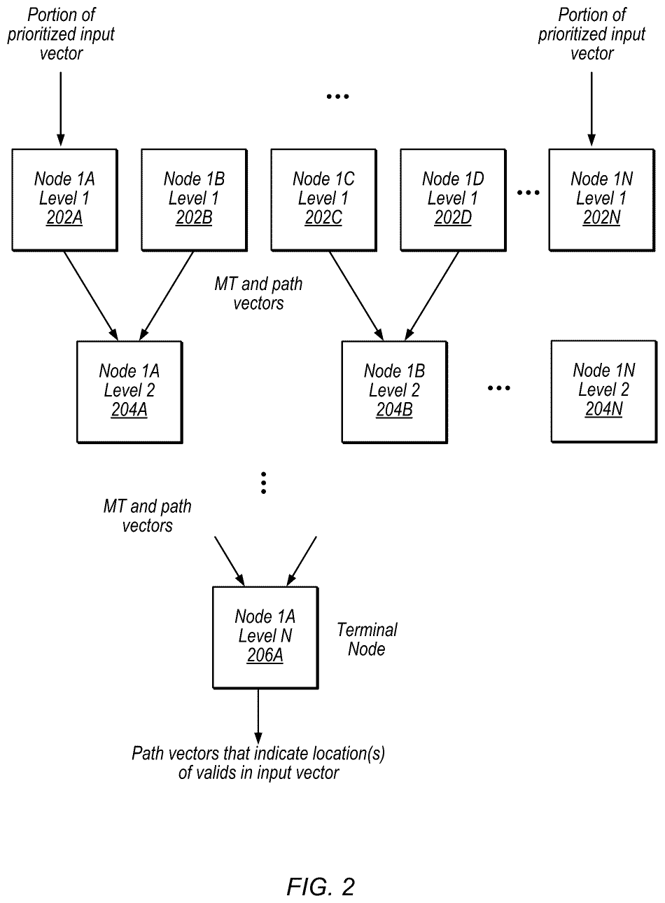

FIG. 2 is a block diagram illustrating a hierarchical tree of nodes, according to some embodiments. In the illustrated example, the tree is an inverted tree with N initial nodes 202A-202N and a single terminal node 206. As shown, each initial node 202 is a circuit that receives a portion of an overall input vector. The nodes generate and propagate more-than (MT) and path vectors and the terminal node 204 produces path vectors that indicate the position of one or more valids in the prioritized input vector.

Each node may process and propagate its parents' MT vectors to generate a new input vector and may utilize one parent's MT vector to select from among the parent's path vectors (and may add to a path vector based on whether it came from a left or right parent).

In some embodiments, each initial node 202 receives a number of elements of the input vector that equals N and the more-than signal output by a given node includes N elements. The value of a more-than signal may indicate the presence of more than a specific number of valid signals (also referred to as “valids”) in the associated vector of input signals. A valid signal may represent a request or a resource, for example. Those skilled in the art will appreciate various types of processors and hardware applicable to the techniques described herein.

In some embodiments, a valid signal may be represented as a bit in an input vector where a one indicates an active request for a resource (or an available resource), and a zero indicates no request (or the resource is not available). For example, if a vector of input signals has valid signals at certain positions (e.g., indices), these positions or locations of the valid signals may represent active requests for resources for allocation.

In some embodiments, the hierarchical tree includes multiple levels of nodes. At each level down from the initial nodes, the hierarchical tree may include half the number of nodes as the previous level. In other embodiments, more complex node logic may be used to process signals from a greater number of parent nodes (e.g., 4, 8, 16, etc.). In some embodiments, at the last level (e.g., level N) of the hierarchy of nodes, there is a single terminal node 206.

### Example Logic to Propagate More-than Signals

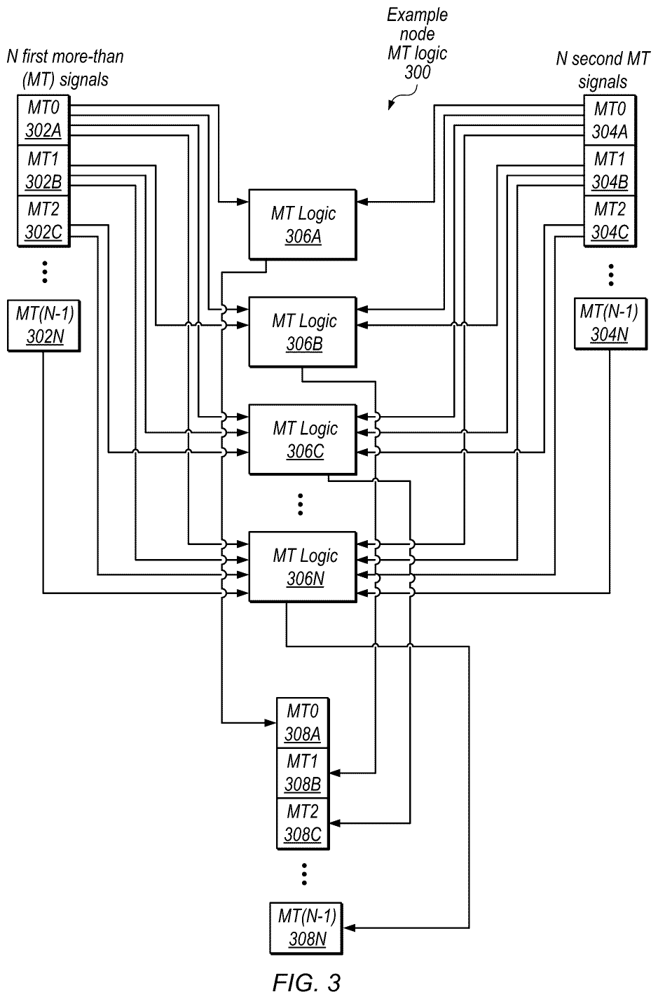

FIG. 3 is a block diagram illustrating example processing and propagation of more-than (MT) signals within a node of a tree-based find-first circuit, according to some embodiments. In the illustrated embodiment, a node includes MT logic 306A-306N configured to process MT signals from the node's parents. In this example, the incoming MT signals include a set of first MT signals 302A-302N from a left-hand parent node and a set of second MT signals 304A-304N from a right-hand parent node are depicted for selection of up to N valids. For example, consider an example in which N is 4. MT 302 and MT 304 may each include N elements in this example. The digit after MT represents the number of valids (e.g., MT0 is more-than zero valids, MT1 is more-than one valid, etc.). For example, MT0 302A indicates whether any valid signals were present in any ancestor nodes corresponding to the left-hand input to MT logic 306. The MT2 signal 302C indicates whether more than two valid signals were present in such ancestor nodes.

Generally, MT logic 306 is configured to generate appropriate more-than signals to reflect the number of valids in the illustrated node's ancestor nodes. Logic 306 may implement AND and OR logic to properly generate MT0 through MT(N−1).

For example, if both parent nodes have MT1 set, they each have at least two valids in the corresponding portion of the input vector. Therefore, there are at least four valids in this node's portion of the input vector and the MT3 bit should be set to indicate more than three valids. As another example, if MT0 is clear in one parent (indicating no valids) and MT2 is set but not MT3 for the other parent, then this node should set its MT0-MT2, but not its MT3. More detailed example logic is discussed below.

For example, the following equations provide the logic to generate a given MT signal for a node at level “row” in the tree hierarchy and index/position “i” within that row.

$$mt 0 [ row ] [ i ] = mt 0 [ row - 1 ] [ 2 * i + 1 ] ‖ mt 0 [ row - 1 ] [ 2 * i ]$$

$$mt 1 [ row ] [ i ] = mt 1 [ row - 1 ] [ 2 * i + 1 ] ‖ mt 1 [ row - 1 ] [ 2 * i ] ‖ mt 0 [ row - 1 ] [ 2 * i + 1 ] \&\& \text{} mt 0 [ row - 1 ] [ 2 * i ]$$

$$mt 2 [ row ] [ i ] = mt 2 [ row - 1 ] [ 2 * i + 1 ] ‖ mt 2 [ row - 1 ] [ 2 * i ] ‖ mt 1 [ row - 1 ] [ 2 * i + 1 ] \&\& \text{} mt 0 [ row - 1 ] [ 2 * i ] ‖ mt 0 [ row - 1 ] [ 2 * i + 1 ] \&\& mt 1 [ row - 1 ] [ 2 * i ]$$

$$mt 3 [ row ] [ i ] = mt 3 [ row - 1 ] [ 2 * i + 1 ] ‖ mt 3 [ row - 1 ] [ 2 * i ] ‖ mt 2 [ row - 1 ] [ 2 * i + 1 ] \&\& \text{} mt 0 [ row - 1 ] [ 2 * i ] ‖ mt 0 [ row - 1 ] [ 2 * i + 1 ] \&\& mt 2 [ row - 1 ] [ 2 * i ] ‖ mt 1 [ row - 1 ] [ 2 * i + 1 ] \&\& mt 1 [ row - 1 ] [ 2 * i ]$$

$$mt 4 [ row ] [ i ] = mt 4 [ row - 1 ] [ 2 * i + 1 ] ‖ mt 4 [ row - 1 ] [ 2 * i ] ‖ mt 3 [ row - 1 ] [ 2 * i + 1 ] \&\& mt 0 [ row - 1 ] [ 2 * i + 1 ] \&\& mt 3 [ row - 1 [ 2 * i ] ‖ mt 2 [ row - 1 ] [ 2 * i + 1 ] \&\& mt 1 [ row - 1 ] [ 2 * i ] ‖ mt 1 [ row - 1 ] [ 2 * i + 1 ] \&\& mt 2 [ row - 1 ] [ 2 * i ]$$

And so on for greater values of N

Note that these equations correspond to a repeating pattern that starts with ORing the mtN signals from the parents and then ORing all the combinations of mtJ and mtK where J+K=N−1. Some combinations that occur multiple times may be simplified, e.g., by a synthesis tool, which may further improve scaling as N increases.

### Example Logic to Propagate Path Signals

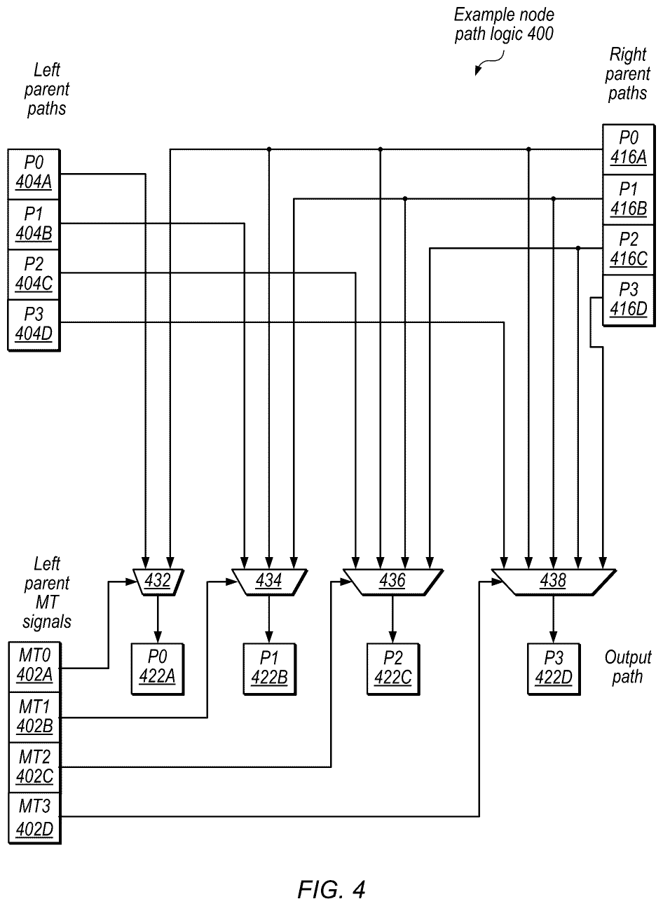

FIG. 4 is a block diagram illustrating example path logic for a given node, according to some embodiments. In the illustrated example, the node receives path bits 404A-404D from the left parent and path bits 416A-416D from the right parent path. The node uses the MT signals from the left parent node to control multiplexers 432, 434, 436, and 438 to select from among the parent path bits to generate an output path (bits 422A-422D).

In particular, the logic selects an appropriate number of path bits from the left parent path based on the highest MT signal that is set (e.g., if MT1 is set and MT2 is not set, the logic selects two path bits P0 and P1 from the left parent). The logic selects the remaining path bits from the right parent path, but demotes their priority position (e.g., if selecting P0 416A and P1 416B which were the first and second bits in the right parent path, those bits become the third and fourth bits in the output path. Prepend logic (not shown), may prepend a bit to a selected path depending on whether the path came from the left parent (e.g., prepending a “1” in embodiments where the MSB has the highest priority) or the right parent (e.g., prepending a “0”).

In some embodiments, a given path output by the terminal node includes a number of bits P sufficient to distinguish among all positions in the input vector, e.g., such that 2^{P}>number of bits in input vector. Paths at higher levels may include lesser numbers of bits, e.g., in embodiments in which the path length grows by one for each level in the tree.

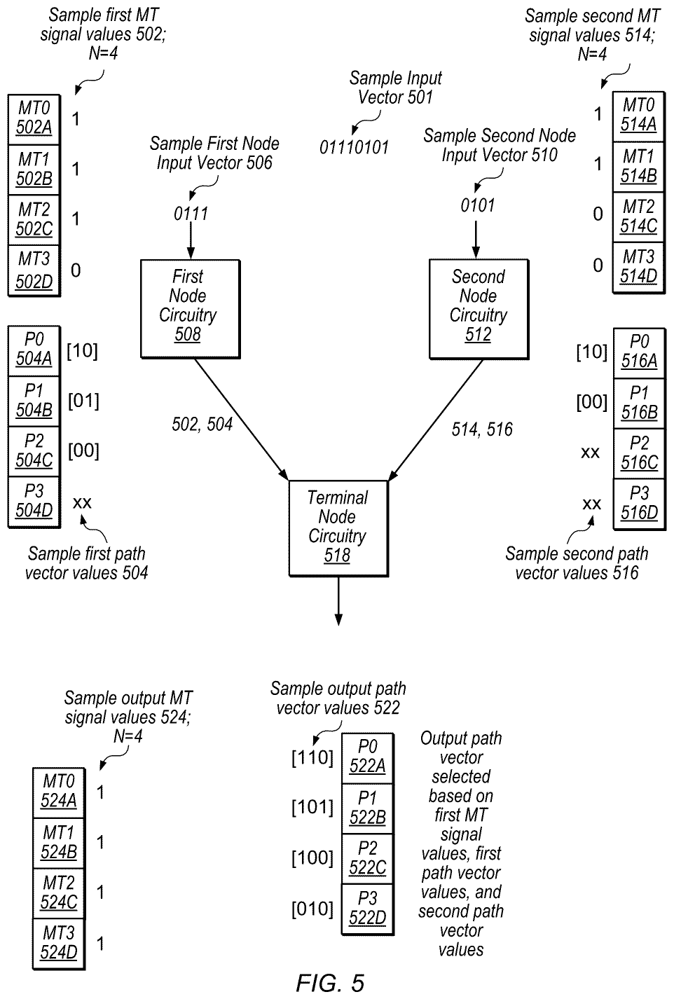

A detailed example with specific example path and MT inputs is discussed below with reference to FIG. 5.

### Example Node Results for Example MT Signals and Path Vectors

FIG. 5 is a block diagram illustrating a hierarchical tree of three nodes with MT signals and path vectors, according to some embodiments. The vectors in the illustrated example of FIG. 5 are shown with values to illustrate the process of finding the first N values of input vector 501, but similar procedures apply to vectors with different values, different widths, etc. In the illustrated example of FIG. 5, an input vector 501, [01110101], includes 8 bits with 5 valids, at indices 0, 2, 4, 5, and 6 (where index 0 corresponds to the least significant bit (LSB) and lowest priority vector element, in this example). In some embodiments, the first N valids may be determined by finding the first N set bits from the starting point of the MSB. For example, for input vector 501 with N=4, the first four valids are at indices 6, 5, 4, and 2.

The hierarchy of nodes illustrated in FIG. 5 includes first node circuitry 508 and second node circuitry 512 at the same level, and terminal node circuitry 518 one level below. In some embodiments, there may be additional nodes (e.g., nodes not illustrated) at one or more parent levels with respect to first node circuitry 508 and second node circuitry 512. In this example, input vector 501 are split into two vectors, first node input vector 506 [0111], and second node input vector 510 [0101] and used as inputs to first node circuitry 508 and second node circuitry 512, respectively. The set of first MT signals 502 corresponding to first node input vector 506, includes N MT signals (e.g., 4 MT signals MT0 502A, MT1 502B, MT2 502C, MT3 502D for N equal to 4). For input vector 506 [0111], there are three valids at indices 0, 1, and 2, so there are more-than 0 valids, more-than 1 valid, and more-than 2 valids but not more-than 3 valids. As such, for first MT signal values 502, MT0 502A, MT1 502B, and MT2 502C may be set to 1 indicating true and MT3 502D are set to 0 indicating false. Similarly, for second node input vector 510, [0101] with two valids at indices 0 and 2, there are more-than 0 valids, more-than 1 valid, but not more-than 2 valids and not more-than 3 valids. Thus, second MT signal values 514, MT0 514A and MT1 514B are set to 1 and MT2 514C and MT3 514D are set to 0.

As shown the path vectors indicate indices of valid bits. For example, consider the input vector 506 to the left parent node 508, [0111] (e.g., valids at indices 2, 1, 0) and corresponding first path vector 504A that indicates the position of the valid at index 2. Similarly path 504B indicates index 1 and path 504C indicates index 0. Path 504D shows “xx” to indicate “don't care” values, e.g., because there are not more than three valids in the input vector 506 to this node. Note that the set of path vectors at a given level may include N paths that indicate up to the first N valid inputs in vector 501. Similarly, set of second path vectors 516 includes first second path vector P0 516A as [10] and second path vector P1 516B as [00] indicating the locations of the first valid and second valid of second node input vector 510, [0101]. The third second path vector 516C and fourth second path vector 516D of set of second path vectors 516 are illustrated as “don't care” values as there is not a third and fourth valid in second node input vector 510. Although a binary number system is illustrated in the example of FIG. 5, different number base systems may also be implemented for the various vectors and signals.

In this example, terminal node circuitry 518 receives MT signals 502 and path vectors 504 and 526. Terminal node circuitry 518 may generate a set of output MT signals 524 indicating the number of total valids received by its respective parent nodes (e.g., first node 508, second node 512). For example, first node input vector 506 includes 3 valids and second node input vector 510 includes 2 valids. As such, MT signals 524 include MT0 524A, MT1 524B, MT2 524C, MT3 524D where all signals are set to 1 since there are 5 valids received by terminal node 518 (e.g., more-than 0, 1, 2, and 3 valids).

In this example, node 518 generates the set of output path vectors 522 based on first MT signal values 502, set of first path vectors 504, and set of second path vectors 516, e.g., according to the techniques discussed above with reference to FIG. 4. In this example, output path vector P0 522A has a value of [110], which indicates the index of the first valid bit of input vector 501. This value is generated by taking path P0 504A and appending a “1,” because the selected path was from the left parent. Similar techniques are used to generate paths P1 522B and P2 522C, which are also propagated from the left parent node 508. Path P4 522D has a value of [010] which corresponds to path P0 516A with a prepended “0” because it comes from the right parent node 512. In this manner, the set of output paths indicate the indices of the first four valids in the input vector 501 (indices 6, 5, 4, and 2).

In some embodiments, each vector of the set of output path vectors 522 may be one-hot encoded to generate a corresponding set of one-hot encoded output path vectors (not illustrated) that represent the location of the first N valid bits of input vector 501. In some embodiments, the node circuitry as illustrated in FIG. 5 may be used to find the first M valid bits when M is less than N.

Note that various disclosed embodiments input N elements of the input vector into a given node at the top level of the tree and path N and nodes propagate MT signals that indicate up to more-than N−1. In other embodiments, different levels may encode MT signals differently, some top-level nodes may receive more than or less than N elements, etc. Disclosed embodiments are included for purposes of implementation, but not included to limit the scope of the present disclosure.

In some embodiments, disclosed techniques may find the first N valids with good performance, e.g., sufficient to operate within a single clock cycle, in some embodiments. The scalability of disclosed techniques may expand the width of arbitration in various processor contexts, which may improve performance for various workloads and design flexibility to facilitate various design goals, with advantages in terms of chip area at certain values of N relative to traditional techniques.

### Example Find-First N Circuitry

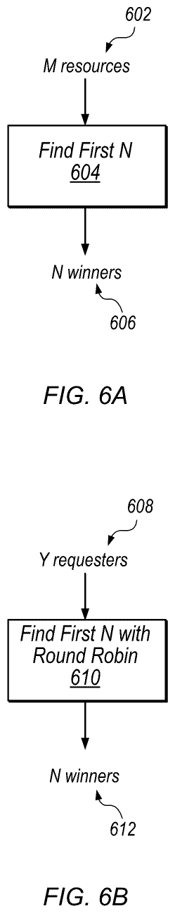

FIGS. 6A and 6B illustrate application of find-first N circuitry to both requesters and resources. In other embodiments, a single find-first-N circuit may be used, e.g., to assign requesters to a fixed number of resources or to select resources from a set of resources, for example.

FIG. 6A is a block diagram illustrating an example of a find-first N system 604 for resources, according to some embodiments. In the illustrated example, find-first N circuitry 604 is configured to receive M resources 602 and identify the first N valid resources. Output vector 606 may be a set of N path vectors indicating the locations (e.g., indices) of the first N valid resources. In other embodiments, control circuitry may provide other output encodings, e.g., converting the path vectors to some other representation such as a one-hot representation. As one example, the one-hot masks may be generated by shifting more-than bits based on a given path. In some embodiments, control circuitry may perform a population count of resource or requestor valids as an input to encoding.

FIG. 6B is a block diagram illustrating an example of a find-first N system 610 for requesters, according to some embodiments. In the illustrated example, find-first N circuitry 610 is configured to receive Y requesters 608 and identify the first N valid requesters. Output vector 612 may be a set of path vectors path vector indicating the locations (e.g., indices) of the first N valid requesters. In the illustrated example, find-first N system 610 uses round-robin arbitration to assign valid requesters. For example, a start pointer may be used to implement round robin (e.g., doubling the valid list and masking it based on the start pointer, with the start pointer moving after a given selection).

The assignment of resource winners to requester winners may be encoded using various techniques. As one example, a two-dimensional matrix of one-hot pointers may indicate which resource is assigned to which requester, based on the outputs of circuitry 604 and 610. This example may avoid excess grant signals and avoid a population count operation.

### Example Method

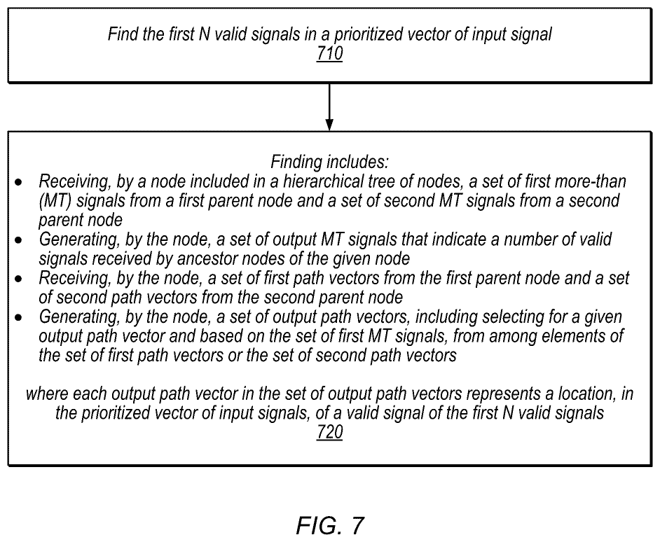

FIG. 7 is a flow diagram illustrating an example method for finding the first N valid signals in a prioritized vector of input signals, according to some embodiments. The method shown in FIG. 7 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 710, in the illustrated embodiment, the computing system finds the first N valid signals in a prioritized vector of input signals (e.g., in input vector 501). In the illustrated example, this finding includes various operations of element 720.

At 720, in the illustrated embodiment, the finding computing system receives, by a node included in a hierarchical tree of nodes, a set of first more-than (MT) signals from a first parent node and a set of second MT signals from a second parent node. For example, terminal node circuitry 518 may receive first MT signals 502 from first node circuitry 508 and second MT signals 514 from second node circuitry 512.

In this example, the node generates a set of output MT signals that indicate a number of valid signals received by ancestor nodes of the node. For example, terminal node circuitry 518 may generate output MT signals 524 which may indicate the number of valid signals received by first node circuitry 508 and second node circuitry 512.

In this example, node receives a set of first path vectors from the first parent node and a set of second path vectors from the second parent node. For example, terminal node circuitry 518 may receive set of first path vectors 504 from first node circuitry 508 and set of second path vectors 516 from second node circuitry 512.

In this example, the node generates a set of output path vectors, including selecting for a given output path vector and based on the set of first MT signals, from among elements of the set of first path vectors or the set of second path vectors. For example, terminal node circuitry 518 may generate set of output path vectors 522. In some embodiments, terminal node circuitry 518 may determine whether to generate a given output path vector of set of output path vectors 522 from an element (e.g., vector) from set of first path vectors 504 or from set of second path vectors 516 based on first MT signals 502.

In this example, each output path vector in the set of output path vectors represents a location, in the prioritized vector of input signals, of a valid signal of the first N valid signals. For example, set of output path vectors 522 may include N output path vectors, where a given output path vector indicates a location or index of a valid in the prioritized vector of input signals (e.g., input vector 501).

In some embodiments, the control circuitry is configured to, for a given output path vector selected from among elements of the set of first path vectors prepend an element to the output path vector based on whether the corresponding path vector was received from the first parent node or the second parent node (e.g., prepending a 1 for the left node or a 0 for the right node). In some embodiments, the quantity of node circuits at each level of the hierarchical tree are one-half (or more generally a smaller quantity) with respect to the quantity of node circuits one level above in the hierarchical tree. In some embodiments, the find-first N circuitry is configured to perform a find-first M operation, where M is less than N, including to generate M output path vectors (this may occur when a given find-first-N circuit receives less than N valids or in a design where a find-first-N circuit was implemented but only M requesters can be valid at a certain location). In some embodiments, the quantity of MT signals is equal to N.

In some embodiments, encode circuitry is configured to one-hot encode the set of output path vectors to generate a corresponding set of one-hot encoded output path vectors, wherein a hot bit in a given one-hot encoded output path vector represents the location in the prioritized vector of one of the N valid signals. In some embodiments, round robin control circuitry configured to control prioritized vectors of input signals over multiple find-first N operations to provide round-robin arbitration among the input signals.

Ion some embodiments, the find-first N circuitry is configured to select valid requesters from among multiple requester circuits requesting to access a set of resources and second find-first N circuitry is configured to select valid resources from the set of resources. Mapping circuitry may assign the valid requesters to the set of resources based on the path vectors output by the find-first N circuitry and the second find-first N circuitry. In some embodiments, the control circuitry is configured to select the set of output path vectors from among elements of the set of second path vectors if the set of first path vectors represents the location of less than the first N valid signals (e.g., select from among the right parent paths in FIG. 4 if the left parent MT signals indicate that the left parent paths represent the location of less than four valid signals).

### Example Device

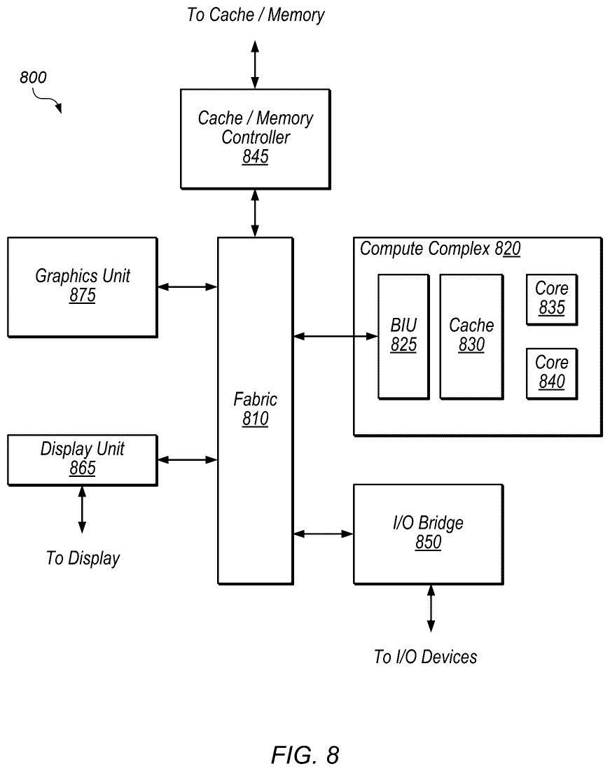

Referring now to FIG. 8, a block diagram illustrating an example embodiment of a device 800 is shown. In some embodiments, elements of device 800 may be included within a system on a chip. In some embodiments, device 800 may be included in a mobile device, which may be battery-powered. Therefore, power consumption by device 800 may be an important design consideration. In the illustrated embodiment, device 800 includes fabric 810, compute complex 820 input/output (I/O) bridge 850, cache/memory controller 845, graphics unit 875, and display unit 865. In some embodiments, device 800 may include other components (not shown) in addition to or in place of the illustrated components, such as video processor encoders and decoders, image processing or recognition elements, computer vision elements, etc.

In some embodiments, disclosed find-first circuitry may be used in or among any of various elements shown in FIG. 8 for arbitration. Disclosed techniques may advantageously improve performance, reduce circuit area, provide flexibility for increasing N in a given design, etc.

Fabric 810 may include various interconnects, buses, MUX's, controllers, etc., and may be configured to facilitate communication between various elements of device 800. In some embodiments, portions of fabric 810 may be configured to implement various different communication protocols. In other embodiments, fabric 810 may implement a single communication protocol and elements coupled to fabric 810 may convert from the single communication protocol to other communication protocols internally.

In the illustrated embodiment, compute complex 820 includes bus interface unit (BIU) 825, cache 830, and cores 835 and 840. In various embodiments, compute complex 820 may include various numbers of processors, processor cores and caches. For example, compute complex 820 may include 1, 2, or 4 processor cores, or any other suitable number. In one embodiment, cache 830 is a set associative L2 cache. In some embodiments, cores 835 and 840 may include internal instruction and data caches. In some embodiments, a coherency unit (not shown) in fabric 810, cache 830, or elsewhere in device 800 may be configured to maintain coherency between various caches of device 800. BIU 825 may be configured to manage communication between compute complex 820 and other elements of device 800. Processor cores such as cores 835 and 840 may be configured to execute instructions of a particular instruction set architecture (ISA) which may include operating system instructions and user application instructions. These instructions may be stored in computer readable medium such as a memory coupled to memory controller 845 discussed below.

As used herein, the term “coupled to” may indicate one or more connections between elements, and a coupling may include intervening elements. For example, in FIG. 8, graphics unit 875 may be described as “coupled to” a memory through fabric 810 and cache/memory controller 845. In contrast, in the illustrated embodiment of FIG. 8, graphics unit 875 is “directly coupled” to fabric 810 because there are no intervening elements.

Cache/memory controller 845 may be configured to manage transfer of data between fabric 810 and one or more caches and memories. For example, cache/memory controller 845 may be coupled to an L3 cache, which may in turn be coupled to a system memory. In other embodiments, cache/memory controller 845 may be directly coupled to a memory. In some embodiments, cache/memory controller 845 may include one or more internal caches. Memory coupled to controller 845 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 845 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 820 to cause the computing device to perform functionality described herein.

Graphics unit 875 may include one or more processors, e.g., one or more graphics processing units (GPUs). Graphics unit 875 may receive graphics-oriented instructions, such as OPENGL®, Metal®, or DIRECT3D® instructions, for example. Graphics unit 875 may execute specialized GPU instructions or perform other operations based on the received graphics-oriented instructions. Graphics unit 875 may generally be configured to process large blocks of data in parallel and may build images in a frame buffer for output to a display, which may be included in the device or may be a separate device. Graphics unit 875 may include transform, lighting, triangle, and rendering engines in one or more graphics processing pipelines. Graphics unit 875 may output pixel information for display images. Graphics unit 875, in various embodiments, may include programmable shader circuitry which may include highly parallel execution cores configured to execute graphics programs, which may include pixel tasks, vertex tasks, and compute tasks (which may or may not be graphics-related).

Display unit 865 may be configured to read data from a frame buffer and provide a stream of pixel values for display. Display unit 865 may be configured as a display pipeline in some embodiments. Additionally, display unit 865 may be configured to blend multiple frames to produce an output frame. Further, display unit 865 may include one or more interfaces (e.g., MIPI® or embedded display port (eDP)) for coupling to a user display (e.g., a touchscreen or an external display).

I/O bridge 850 may include various elements configured to implement: universal serial bus (USB) communications, security, audio, and low-power always-on functionality, for example. I/O bridge 850 may also include interfaces such as pulse-width modulation (PWM), general-purpose input/output (GPIO), serial peripheral interface (SPI), and inter-integrated circuit (I2C), for example. Various types of peripherals and devices may be coupled to device 800 via I/O bridge 850.

In some embodiments, device 800 includes network interface circuitry (not explicitly shown), which may be connected to fabric 810 or I/O bridge 850. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 800 with connectivity to various types of other devices and networks.

### Example Applications

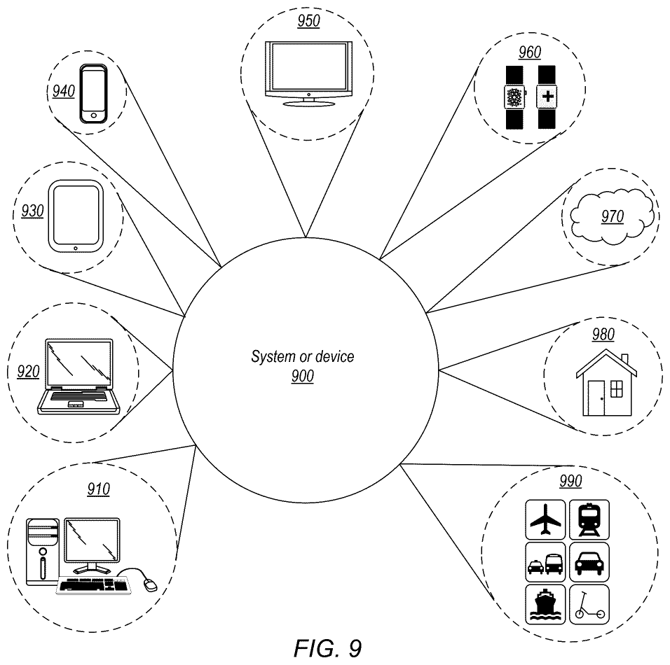

Turning now to FIG. 9, various types of systems that may include any of the circuits, devices, or system discussed above. System or device 900, which may incorporate or otherwise utilize one or more of the techniques described herein, may be utilized in a wide range of areas. For example, system or device 900 may be utilized as part of the hardware of systems such as a desktop computer 910, laptop computer 920, tablet computer 930, cellular or mobile phone 940, or television 950 (or set-top box coupled to a television).

Similarly, disclosed elements may be utilized in a wearable device 960, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 900 may also be used in various other contexts. For example, system or device 900 may be utilized in the context of a server computer system, such as a dedicated server or on shared hardware that implements a cloud-based service 970. Still further, system or device 900 may be implemented in a wide range of specialized everyday devices, including devices 980 commonly found in the home such as refrigerators, thermostats, security cameras, etc. The interconnection of such devices is often referred to as the “Internet of Things” (IoT). Elements may also be implemented in various modes of transportation. For example, system or device 900 could be employed in the control systems, guidance systems, entertainment systems, etc. of various types of vehicles 990.

The applications illustrated in FIG. 9 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

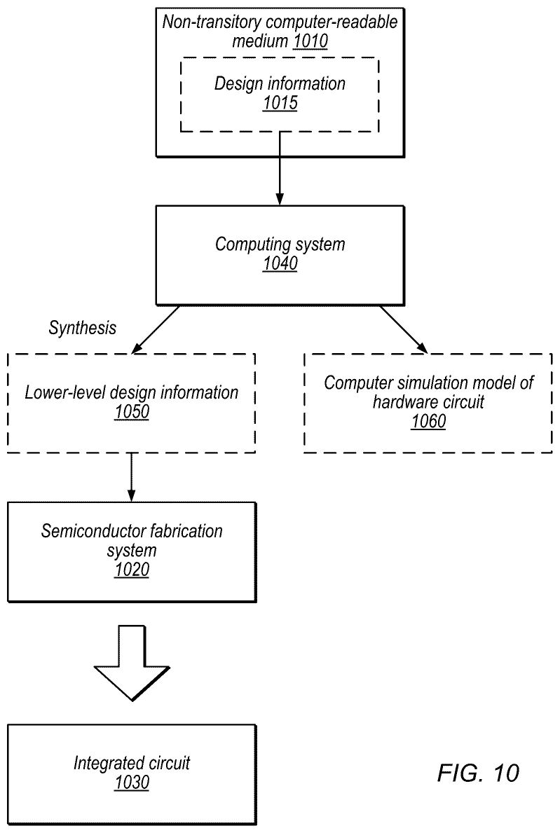

FIG. 10 is a block diagram illustrating an example non-transitory computer-readable storage medium that stores circuit design information, according to some embodiments. In the illustrated embodiment, computing system 1040 is configured to process the design information. This may include executing instructions included in the design information, interpreting instructions included in the design information, compiling, transforming, or otherwise updating the design information, etc. Therefore, the design information controls computing system 1040 (e.g., by programming computing system 1040) to perform various operations discussed below, in some embodiments.

In the illustrated example, computing system 1040 processes the design information to generate both a computer simulation model of a hardware circuit 1060 and lower-level design information 1050. In other embodiments, computing system 1040 may generate only one of these outputs, may generate other outputs based on the design information, or both. Regarding the computing simulation, computing system 1040 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1040 also processes the design information to generate lower-level design information 1050 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1050 (potentially among other inputs), semiconductor fabrication system 1020 is configured to fabricate an integrated circuit 1030 (which may correspond to functionality of the simulation model 1060). Note that computing system 1040 may generate different simulation models based on design information at various levels of description, including information 1050, 1015, and so on. The data representing design information 1050 and model 1060 may be stored on medium 1010 or on one or more other media.

In some embodiments, the lower-level design information 1050 controls (e.g., programs) the semiconductor fabrication system 1020 to fabricate the integrated circuit 1030. Thus, when processed by the fabrication system, the design information may program the fabrication system to fabricate a circuit that includes various circuitry disclosed herein.

Non-transitory computer-readable storage medium 1010, may comprise any of various appropriate types of memory devices or storage devices. Non-transitory computer-readable storage medium 1010 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1010 may include other types of non-transitory memory as well or combinations thereof. Accordingly, non-transitory computer-readable storage medium 1010 may include two or more memory media; such media may reside in different locations—for example, in different computer systems that are connected over a network.

Design information 1015 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1040, semiconductor fabrication system 1020, or both. In some embodiments, design information may also include one or more cell libraries that specify the synthesis, layout, or both of integrated circuit 1030. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1030 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1020 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1020 may also be configured to perform various testing of fabricated circuits for correct operation.

In various embodiments, integrated circuit 1030 and model 1060 are configured to operate according to a circuit design specified by design information 1015, which may include performing any of the functionality described herein. For example, integrated circuit 1030 may include any of various elements shown in FIGS. 1B, 2, 3, 4, 5, 6A, and 6B. Further, integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1020 to fabricate integrated circuit 1030.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
find-first N circuitry configured to find the first N valid signals in a prioritized vector of input signals, including:
a plurality of node circuits configured in a hierarchical tree, wherein a given node circuit includes:
control circuitry configured to:
receive a set of first more-than (MT) signals from a first parent node and a set of second MT signals from a second parent node;
generate a set of output MT signals that indicate a number of valid signals received by ancestor nodes of the given node circuit;
path control circuitry configured to:
receive a set of first path vectors from the first parent node and a set of second path vectors from the second parent node;
generate, via a terminal node of the plurality of node circuits, a set of output path vectors, including to select for a given output path vector and based on the set of first MT signals, from among elements of the set of first path vectors or the set of second path vectors;
wherein each output path vector in the set of output path vectors represents a location, in the prioritized vector of input signals, of a valid signal of the first N valid signals.

2. The apparatus of claim 1, wherein the control circuitry is configured to, for a given output path vector selected from among elements of the set of first path vectors prepend an element to the output path vector based on whether the corresponding path vector was received from the first parent node or the second parent node.

3. The apparatus of claim 1, wherein the quantity of node circuits at each level of the hierarchical tree are one-half with respect to the quantity of node circuits one level above in the hierarchical tree.

4. The apparatus of claim 1, wherein the find-first N circuitry is configured to perform a find-first M operation, where M is less than N, including to generate M output path vectors.

5. The apparatus of claim 1, wherein the quantity of first MT signals is equal to N.

6. The apparatus of claim 1, further comprising:
encode circuitry configured to one-hot encode the set of output path vectors to generate a corresponding set of one-hot encoded output path vectors, wherein a hot bit in a given one-hot encoded output path vector represents the location in the prioritized vector of one of the N valid signals.

7. The apparatus of claim 1, further comprising:
round robin control circuitry configured to control prioritized vectors of input signals over multiple find-first N operations to provide round-robin arbitration among the input signals.

8. The apparatus of claim 1, wherein the find-first N circuitry is configured to select valid requesters from among multiple requester circuits requesting to access a set of resources, the apparatus further comprising:
second find-first N circuitry configured to select valid resources from the set of resources; and
mapping circuitry configured to assign the valid requesters to the set of resources based on the path vectors output by the find-first N circuitry and the second find-first N circuitry.

9. The apparatus of claim 1, wherein the control circuitry is configured to select the set of output path vectors from among elements of the set of second path vectors if the set of first path vectors represents the location of less than the first N valid signals.

10. A method, comprising:
finding, by a computing system, the first N valid signals in a prioritized vector of input signals, wherein the finding includes:
receiving, by a node included in a hierarchical tree of nodes, a set of first more-than (MT) signals from a first parent node and a set of second MT signals from a second parent node;
generating, by the node, a set of output MT signals that indicate a number of valid signals received by ancestor nodes of the given node;
receiving, by the node, a set of first path vectors from the first parent node and a set of second path vectors from the second parent node;
generating, by the node, a set of output path vectors, including selecting for a given output path vector and based on the set of first MT signals, from among elements of the set of first path vectors or the set of second path vectors;
wherein each output path vector in the set of output path vectors represents a location, in the prioritized vector of input signals, of a valid signal of the first N valid signals.

11. The method of claim 10, further comprising:
wherein for a given output path vector selected from among elements of the set of first path vectors, prepending an element to the output path vector based on whether the corresponding path vector was received from the first parent node or the second parent node.

12. The method of claim 10, wherein the quantity of nodes at each level of the hierarchical tree of nodes are one-half with respect to the quantity of nodes one level above in the hierarchical tree of nodes.

13. The method of claim 10, further comprising:
finding, via the computing system, the first M valid signals in the prioritized vector input signals, where M is less than N; and
generating M output path vectors.

14. The method of claim 10, wherein the quantity of first MT signals is equal to N.

15. The method of claim 10, further comprising:
encoding, via the computing system, the set of output path vectors; and
generating, via the computing system, a set of one-hot encoded output path vectors corresponding to the set of output path vectors, wherein a hot bit in a given one-hot encoded output path vector represents the location in the prioritized vector of one of the N valid signals.

16. A non-transitory computer-readable medium having instructions of a hardware description programming language stored thereon that, when processed by a computing system, program the computing system to generate a computer simulation model, wherein the model represents a hardware circuit that includes:
a plurality of node circuits configured in a hierarchical tree, wherein a given node circuit includes:
control circuitry configured to:
receive a set of first more-than (MT) signals from a first parent node and a set of second MT signals from a second parent node;
generate a set of output MT signals that indicate a number of valid signals received by ancestor nodes of the given node circuit;
path control circuitry configured to:
receive a set of first path vectors from the first parent node and a set of second path vectors from the second parent node;
generate, via a terminal node of the plurality of node circuits, a set of output path vectors, including to select for a given output path vector and based on the set of first MT signals, from among elements of the set of first path vectors or the set of second path vectors;
wherein each output path vector in the set of output path vectors represents a location, in the prioritized vector of input signals, of a valid signal of the first N valid signals.

17. The non-transitory computer-readable medium of claim 16, wherein the control circuitry is configured to, for a given output path vector selected from among elements of the set of first path vectors prepend an element to the output path vector based on whether the corresponding path vector was received from the first parent node or the second parent node.

18. The non-transitory computer-readable medium of claim 16, wherein the quantity of node circuits at each level of the hierarchical tree are one-half with respect to the quantity of node circuits one level above in the hierarchical tree.

19. The non-transitory computer-readable medium of claim 16, wherein the quantity of first MT signals is equal to N.

20. The non-transitory transitory computer-readable medium of claim 16, further comprising:
encode circuitry configured to one-hot encode the set of output path vectors to generate a corresponding set of one-hot encoded output path vectors, wherein a hot bit in a given one-hot encoded output path vector represents the location in the prioritized vector of one of the N valid signals.
